(19) United States
(12) Patent Application Publication
(10) Pub. No.: US 2020/0194937 A1
(43) Pub. Date: Jun. 18, 2020

(54) INNER CONDUCTOR TERMINAL AND SHIELD CONNECTOR

(71) Applicants: AutoNetworks Technologies, Ltd., Yokkaichi-shi , Mie (JP); Sumitomo Wiring Systems, Ltd., Yokkaichi-shi , Mie (JP); SUMITOMO ELECTRIC INDUSTRIES, LTD., Osaka-shi, Osaka (JP)

(72) Inventors: Hiroyoshi MAESOBA, Yokkaichi-shi, Mie (JP); Toshifumi ICHIO, Yokkaichi-shi, Mie (JP); Kyouichirou NAKATSUGI, Osaka-shi, Osaka (JP)

(21) Appl. No.: 16/500,540

(22) PCT Filed: Mar. 26, 2018
(86) PCT No.: PCT/JP2018/012028

§ 371 Date: Oct. 3, 2019

(30) Foreign Application Priority Data
Apr. 5, 2017 (JP) 2017-074917

(51) Int. Cl. H01R 13/6581; H01R 13/193; H01R 24/38; H01R 13/20

(52) U.S. Cl. CPC H01R 13/6581; H01R 13/20; H01R 24/38; H01R 13/193

(57) ABSTRACT

An inner conductor terminal for a shield connector includes a terminal connecting portion to be connected to a counterpart terminal. A base plate is provided continuously with the terminal connecting portion and has a soldering surface on which a conductor of a shield cable is placed and soldered. The shield cable includes the conductor and an insulation coating covering an outer periphery of the conductor. The conductor is exposed at a terminal portion of the shield cable. A conductor holding portion is arranged opposite to the conductor so as to be contactable with the conductor placed on the soldering surface in a direction where the conductor is separated from the soldering surface.

### BACKGROUND

### Field of the Invention

The present invention relates to an inner conductor terminal and a shield connector provided with a dielectric that accommodates the inner conductor terminal.

### Related Art

Conventional shield connectors used in communication systems such as vehicle-mounted cameras have been known. For example, a shield connector described in JP 2005-203217 A includes a shield shell (a lower portion of an outer conductor terminal) connected to a braid (a shield member) of a shield cable, a shield cover (an upper portion of the outer conductor terminal) attached to the shield shell, a plurality of inner conductor terminals connected to ends of signal lines of the shield cable, and a dielectric housing (a dielectric) for accommodating and holding the inner conductor terminals. In this case, the inner conductor terminals, the dielectric housing and the end of the shield cable are shielded by the shield shell and the shield cover.

Each of the inner conductor terminals includes a fitting portion (a terminal connecting portion) to be connected to a male inner conductor terminal (a counterpart terminal) and a signal line connecting portion to be connected to a conductor of the signal line. The signal line connecting portion is provided with front and rear pairs of pressure contact blades standing upright. An insulating inner sheath of the signal line is torn by the pressure contact blades, and thereby the conductor is conductively brought into contact with the pressure contact blades.

In the above case, a longitudinal length of the inner conductor terminal tends to be long due to the presence of the pressure contact blades arranged side by side in the front and back, so that it is inconvenient for the inner conductor terminal to be applied to a small vehicle-mounted camera module and the like. In view of this, the method of eliminating the pressure contact blades and connecting the conductor by soldering onto a bottom wall portion continued to the rear of the fitting portion in the inner conductor terminal can be employed. However, when the conductor is placed on the bottom wall portion, the conductor tends to be lifted up by a reaction force, which makes it difficult to perform the soldering. As a result, assembling workability of the shield connector may be deteriorated.

The present invention is completed based on the above circumstances, and it is an object to improve assembling workability of a shield connector provided with an inner conductor terminal to which a conductor of a shield cable is soldered.

### SUMMARY

According to the present invention, an inner conductor terminal for a shield connector includes: a terminal connecting portion to be connected to a counterpart terminal; a base plate portion provided continuously with the terminal connecting portion and having a soldering surface on which a conductor of a shield cable is placed and soldered, the shield cable including the conductor and an insulation coating covering an outer periphery of the conductor, and the conductor being exposed at a terminal portion of the shield cable; and a conductor holding portion arranged opposite to the conductor so as to be contactable with the conductor placed on the soldering surface in a direction where the conductor is separated from the soldering surface.

When the conductor of the shield cable is going to be soldered onto the soldering surface of the base plate portion, the conductor is prevented from lifting from the soldering surface by coming into contact with the conductor holding portion. Accordingly, soldering can be performed easily and assembling workability of the shield connector can be improved.

### BRIEF DESCRIPTION OF DRAWINGS

FIG. 1 is an exploded perspective view of a shield connector according to a first embodiment of the present invention.

FIG. 2 is an exploded perspective view of a dielectric and inner conductor terminals.

FIG. 3 is an exploded perspective view of the dielectric and the inner conductor terminals seen from a direction different from FIG. 2.

FIG. 4 is a perspective view of a state in which the inner conductor terminals are assembled to the dielectric.

FIG. 5 is a cross-sectional view of the state in which the inner conductor terminals are assembled to the dielectric.

FIG. 6 is a perspective view of a housing.

FIG. 7 is a cross-sectional view of the housing.

FIG. 8 is a perspective view of a lower shell terminal.

FIG. 9 is a perspective view of an upper shell terminal.

FIG. 10 is a perspective view of a cable side unit during assembly.

FIG. 11 is a perspective view of a state in which the cable side unit is further assembled from the state of FIG. 10.

FIG. 12 is a cross-sectional view of the state in which the cable side unit is further assembled from the state of FIG. 10.

FIG. 13 is a perspective view of a state in which the cable side unit is further assembled from the state of FIG. 11.

FIG. 14 is a perspective view of the cable side unit.

FIG. 15 is a cross-sectional view of the cable side unit.

FIG. 16 is a perspective view of a state in which the cable side unit is assembled to the housing.

FIG. 17 is a perspective view of the shield connector.

FIG. 18 is a cross-sectional view of a state in which the shield connector is fitted to a counterpart shield connector.

FIG. 19 is a view corresponding to FIG. 2 of a shield connector according to a second embodiment of the present invention.

FIG. 20 is a side view of an inner conductor terminal according to the second embodiment.

FIG. 21 is a perspective view of a main part of a cable side unit according to the second embodiment.

FIG. 22 is a view corresponding to FIG. 2 of a shield connector according to a third embodiment of the present invention.

FIG. 23 is a perspective view of a main part of a cable side unit according to the third embodiment during assembly.

FIG. 24 is a perspective view of the main part of the cable side unit according to the third embodiment.

### DETAILED DESCRIPTION

A preferable embodiment of the present invention is shown below.

The conductor holding portion may include a holding main body disposed opposite to the soldering surface, and a connecting portion connecting the holding main body and the base plate portion. According to this configuration, the holding main body is integrally formed with the base plate portion via the connecting portion, with the result that the inner conductor terminal can be easily manufactured.

Preferably, the connecting portions may be raised in pairs from the base plate portion, and the pair of connecting portions, the holding main body, and the base plate portion may form a cylindrical shape, and further, the holding main body may be provided double in a direction opposite to the soldering surface. Since the conductor holding portion and the base plate portion forms a cylindrical shape, strength of this portion can be enhanced. On the other hand, there is a concern that the cylindrical shaped portion may be opened. According to the above configuration, however, the cylindrical shaped portion is prevented from being opened since the holding main body is provided double in the direction opposite to the soldering surface.

Preferably, the conductor holding portion may include an elastic holding piece that is flexibly deformable and presses and holds the conductor against the soldering surface. According to this configuration, the conductor is reliably prevented from lifting from the soldering surface.

Preferably, the conductor holding portion may include a holding main body disposed opposite to the soldering surface, and a connecting portion connecting the holding main body and the base plate portion, and a conductor introduction port may be formed in an inner space partitioned by the connecting portion, the holding main body, and the base plate portion, the conductor introduction port being opened to an opposite side to a side of the terminal connecting portion. Further, the elastic holding piece may include a portion projecting from the holding main body toward the side of the terminal connecting portion so as to gradually approach the soldering surface. According to this configuration, the conductor is inserted into the inner space through the conductor introduction port which is opened to the opposite side to the side of the terminal connecting portion, whereby the conductor is held in a state where lifting of the conductor is restricted by the elastic holding piece. As a result, subsequent soldering operation can be quickly performed and workability is further improved.

Preferably, the conductor holding portion may include a pair of guide portions approaching each other toward a side of the base plate portion, and a conductor introduction port may be formed between the pair of guide portions so as to be opened toward the soldering surface. According to this configuration, since the conductor can be inserted toward the soldering surface, the workability is further improved.

Preferably, a shield connector having the inner conductor terminal of the above-described configuration may include: an insulating dielectric having a terminal accommodation portion for accommodating the inner conductor terminal; and an outer conductor terminal surrounding the inner conductor terminal via the dielectric and connected to a shield member of the shield cable. The dielectric may have an opening portion not covering the soldering surface of the inner conductor terminal accommodated in the terminal accommodation portion. According to this configuration, the conductor can be soldered onto the soldering surface of the inner conductor terminal through the opening portion in a state where the inner conductor terminal is accommodated in the terminal accommodation portion of the dielectric. As a result, the workability is further improved.

### First Embodiment

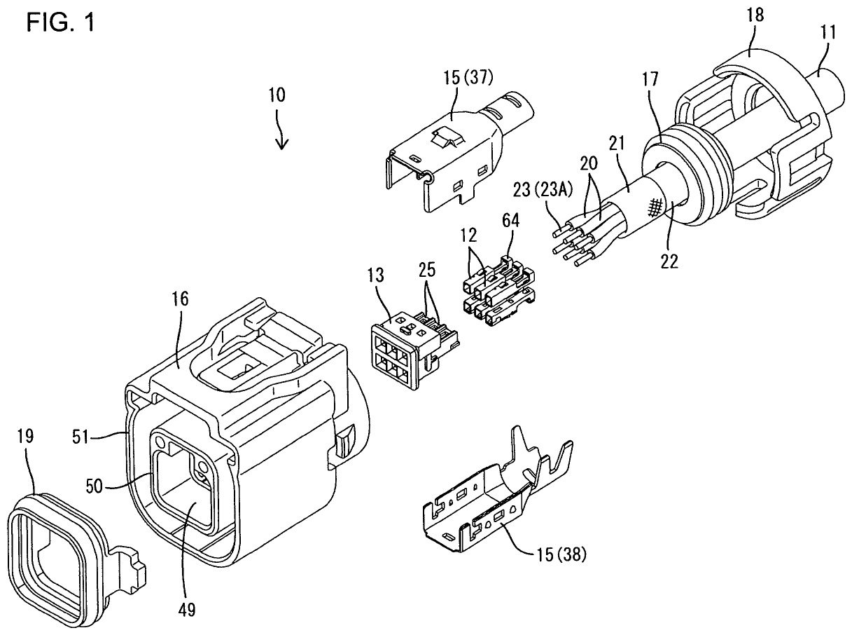

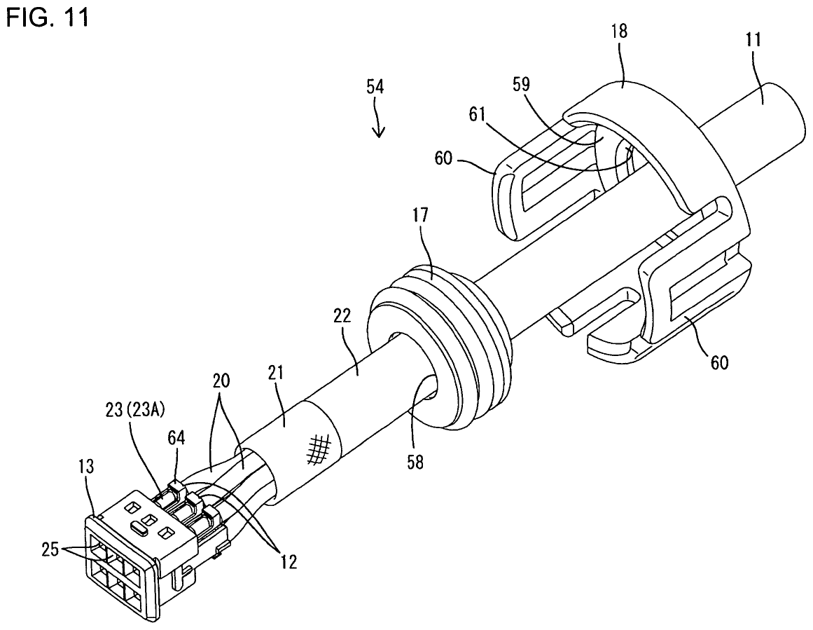

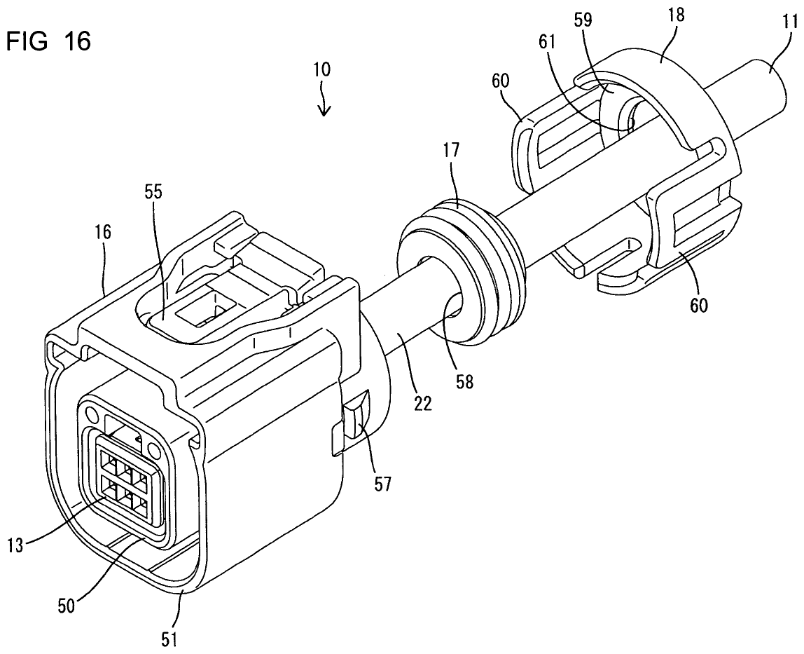

A first embodiment of the present invention will be described below with reference to FIG. 1 to FIG. 18. A shield connector 10 according to the first embodiment exemplifies a connector for communication mounted on a vehicle such as an electric car or a hybrid car, and is fittable to a counterpart shield connector 100 provided on a vehicle-mounted camera module such as a back monitor camera. As shown in FIG. 1, the shield connector 10 includes a shield cable 11, a plurality of inner conductor terminals 12, a dielectric 13, an outer conductor terminal 15, a housing 16, a rubber plug 17, a rubber plug press member 18 and a rubber ring 19. In the following description, as to a front-rear direction, a side to which the shield connector 10 and the counterpart shield connector 100 face each other at a start of fitting is defined as a front side. A structure and operation of the inner conductor terminal 12 will be described in detail in the latter half of the description of the first embodiment.

[Counterpart Shield Connector]

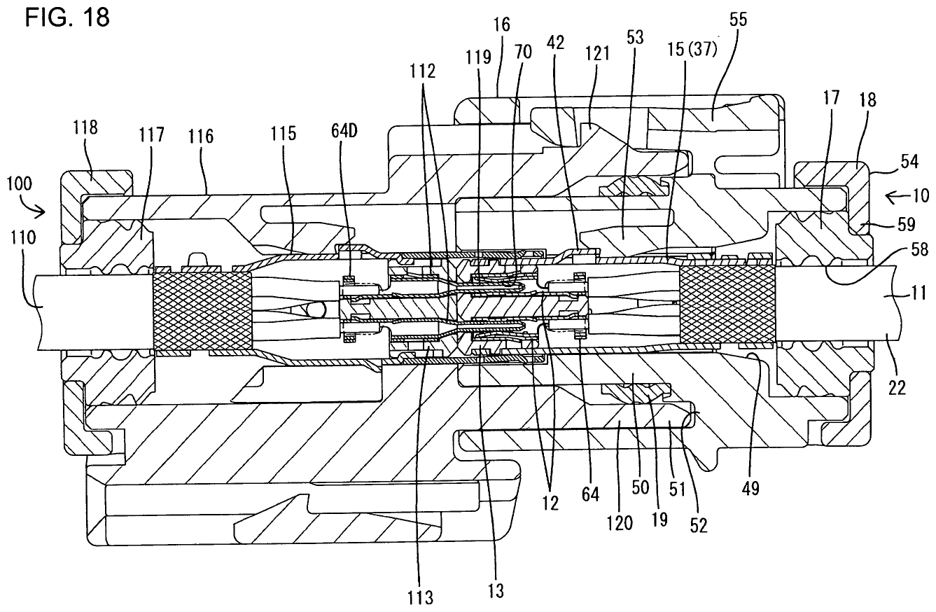

As shown in FIG. 18, the counterpart shield connector 100 has the similar configuration as the shield connector 10, and includes a counterpart shield cable 110, a plurality of counterpart terminals 112, a counterpart dielectric 113, a counterpart outer conductor terminal 115, a counterpart housing 116, a counterpart rubber plug 117, and a counterpart rubber plug press member 118.

Each of the counterpart terminals 112 is a male terminal fitting having a tab 119 projecting forward. The counterpart terminals 112 are connected to a terminal portion of the counterpart shield cable 110 and accommodated in the counterpart dielectric 113. The counterpart housing 116 has a cylindrical hood portion 120 projecting forward from a region where the counterpart dielectric 113 is accommodated, and the tabs 119 of the counterpart terminals 112 are protrudingly disposed in the hood portion 120. A lock protrusion 121 is provided on an upper surface of an upper wall of the hood portion 120. The counterpart shield cable 110, the counterpart dielectric 113, the counterpart outer conductor terminal 115, the counterpart rubber plug 117 and the counterpart rubber plug press member 118 have the same basic structures as the shield cable 11, the shield connector 10, the dielectric 13, the outer conductor terminal 15, the rubber plug 17, and the rubber plug press member 18, respectively. The above-described members of the shield connector 10 will be described later, and therefore descriptions of the respective members of the counterpart shield connector 100 are omitted here.

[Shield Cable]

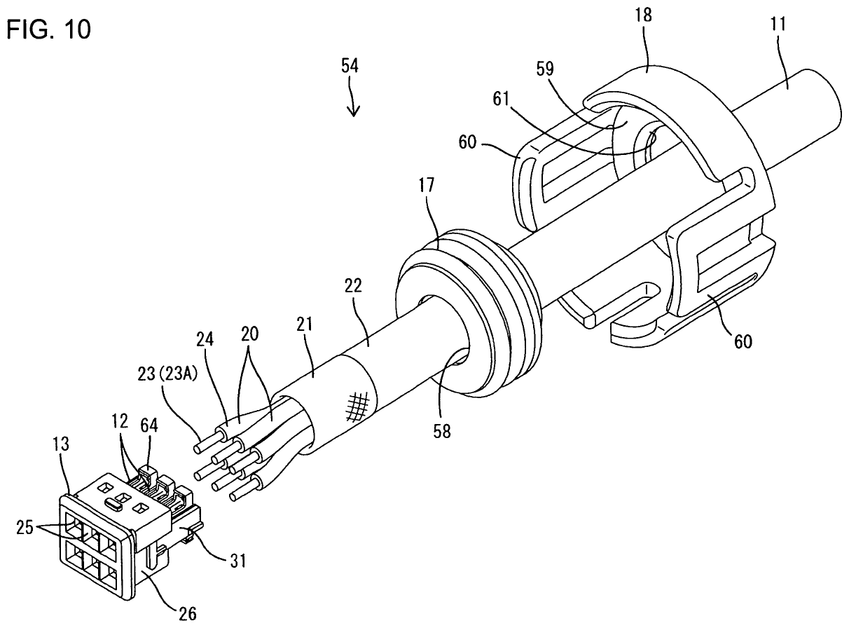

The shield cable 11 is a cable capable of high-speed communication, and as shown in FIG. 10, is composed of a plurality of electric wires 20 as signal lines, a shield member 21 collectively surrounding the electric wires 20, and an insulating sheath 22 covering an outer periphery of the shield member 21. In a case of the first embodiment, a braided wire made by braiding metal element wires is used as the shield member 21. However, a metal foil such as aluminum foil, for example, may be used instead of the braided wire.

Each electric wire 20 is composed of a conductor 23 which is composed of a plurality of core wires, and an insulation coating 24 which covers an outer periphery of the conductor 23. Each of the core wires constituting the conductor 23 is a conductive wire having copper or aluminum as a main component, and the core wires are twisted together.

Each electric wire 20 has a terminal portion in which the insulation coating 24 is peeled off so that the conductor 23 is exposed. The exposed conductor (hereinafter referred to as a conductor exposed portion 23A) is connected to the inner conductor terminal 12 by soldering. Prior to soldering, preliminary soldering is applied to the conductor exposed portion 23A, whereby the conductor exposed portion 23A is formed into a single core shape to be integrated so as not to be separated. At a terminal portion of the shield cable 11, the conductor exposed portion 23A, the insulation coating 24, and a terminal portion of the shield member 21 are arranged to be exposed in a stepwise manner.

[Dielectric]

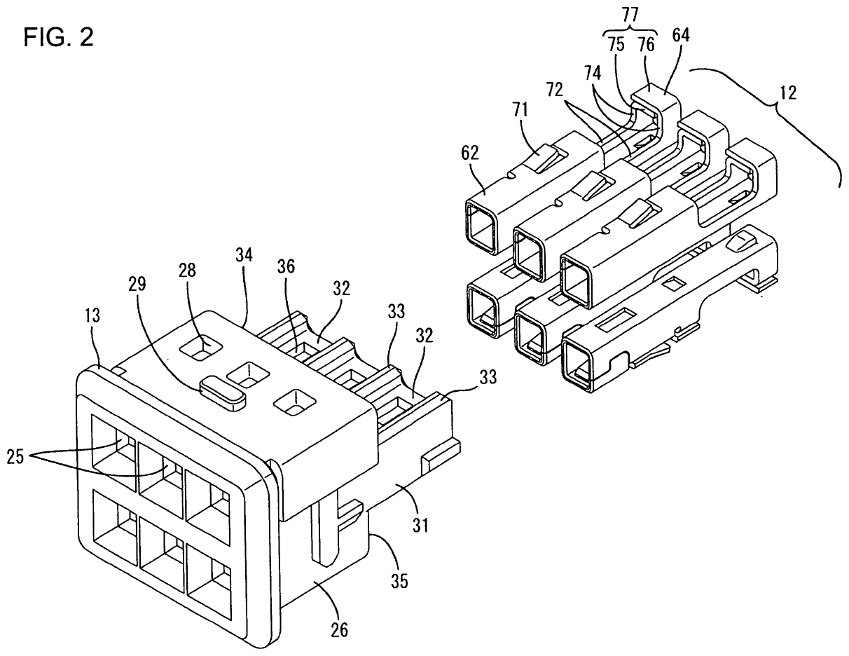

The dielectric 13 is an insulating synthetic resin material, and as shown in FIG. 2, has a plurality of terminal accommodation portions 25 for accommodating the respective inner conductor terminals 12. The terminal accommodation portions 25 are arranged side by side in upper and lower two stages so as to correspond to arrangement of the inner conductor terminals 12.

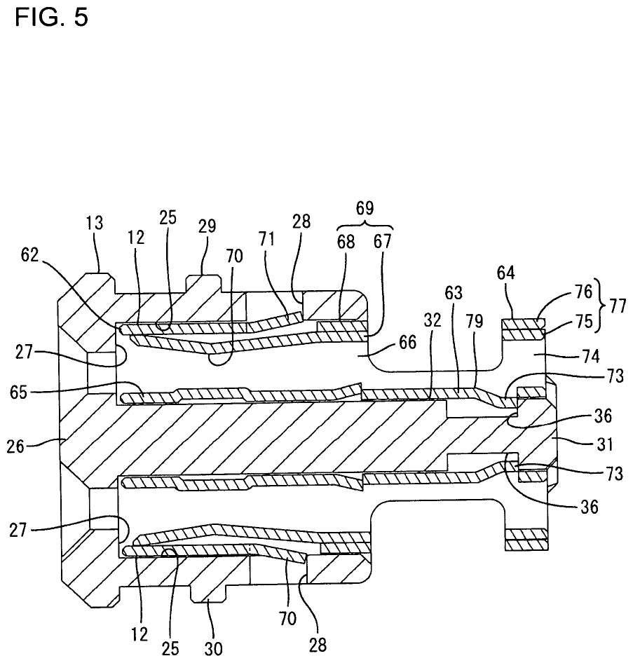

A front portion of the dielectric 13 is a main body 26 having a substantially square block shape. In the main body 26, front portions of the respective terminal accommodation portions 25 are arranged side by side each of which has a tunnel shape circumferentially closed in a rectangular shape in cross section. As shown in FIG. 5, the inner wall of the front portion of the terminal accommodation portion 25 in the main body 26 is provided with a stepped portion 27 which can stop the inner conductor terminal 12 from advancing.

In upper and lower walls of the main body 26, front engaging holes 28 are provided penetrating therethrough so as to respectively communicate with the upper and lower terminal accommodation portions 25. Further, the upper and lower walls of the main body 26 are provided with an upper positioning portion 29 and a lower positioning portion 30, respectively, each of which has a flat and protruding shape.

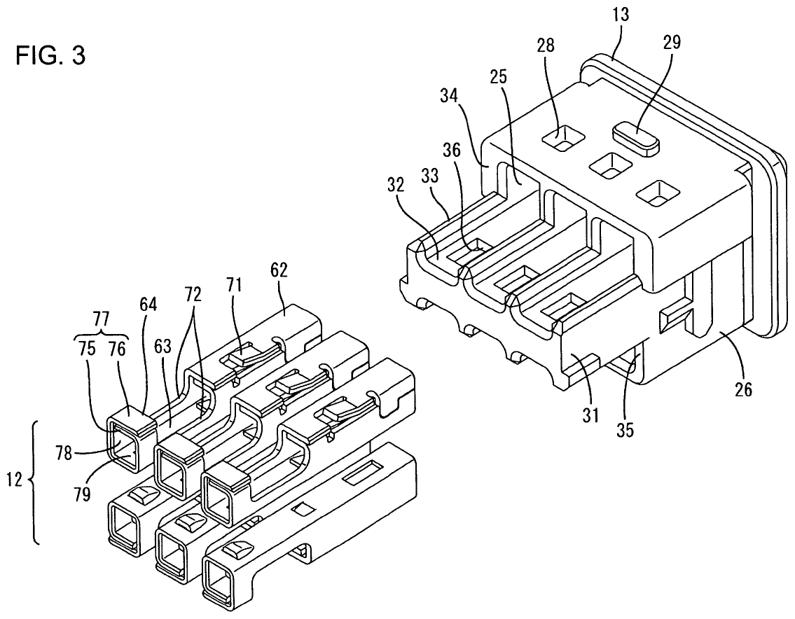

A rear portion of the dielectric 13 is a projection piece 31 having a horizontal plate shape projecting rearward from a vertically middle portion of the main body 26 between the upper and lower terminal accommodation portions 25. On upper and lower surfaces of the projection piece 31, terminal support surfaces 32 continuous from the respective front portions of the terminal accommodation portions 25 are arranged side by side, and left and right sides of each terminal support surface 32 are provided with rib-shaped partition walls 33 extending in the front-rear direction. A rear portion of each terminal accommodation portion 25 is partitioned by the corresponding terminal support surface 32 and the left and right partition walls 33 in the upper and lower surfaces of the projection piece 31. Further, as shown in FIG. 3, on an upper side of the projection piece 31, an upper opening 34 is provided for opening the rear portions of the terminal accommodation portions 25 in the upper stage, and on a lower side of the projection piece 31, a lower opening 35 is provided for opening the rear portions of the terminal accommodation portions 25 in the lower stage. Further, on the upper and lower surfaces of the projection piece 31, a bottomed rear engaging hole 36 is provided in each terminal support surface 32 so as to be opened therein.

[Outer Conductor Terminal]

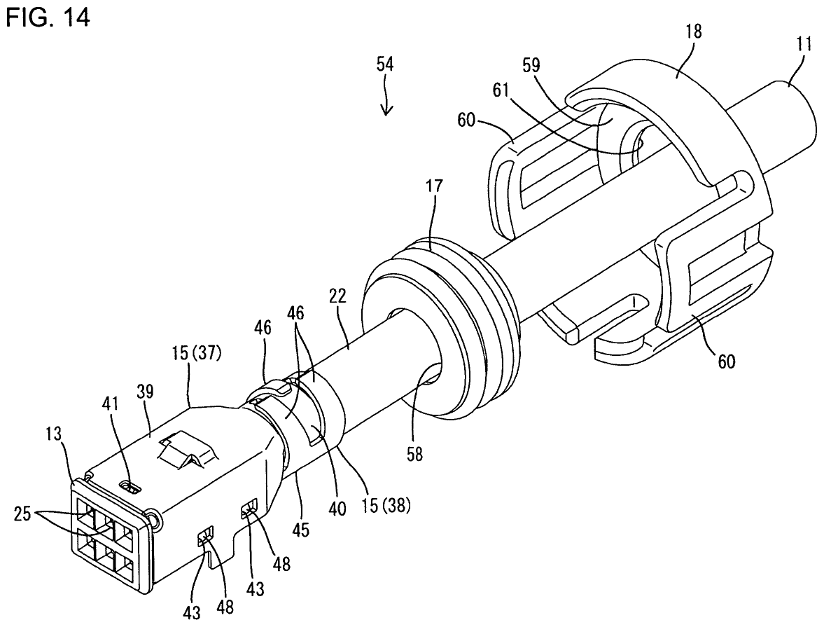

The outer conductor terminal 15 is a conductive metal plate having copper or aluminum as a main component, and as shown in FIG. 1 and FIG. 14, is composed of an upper shell terminal 37 and a lower shell terminal 38 that can be vertically divided from each other.

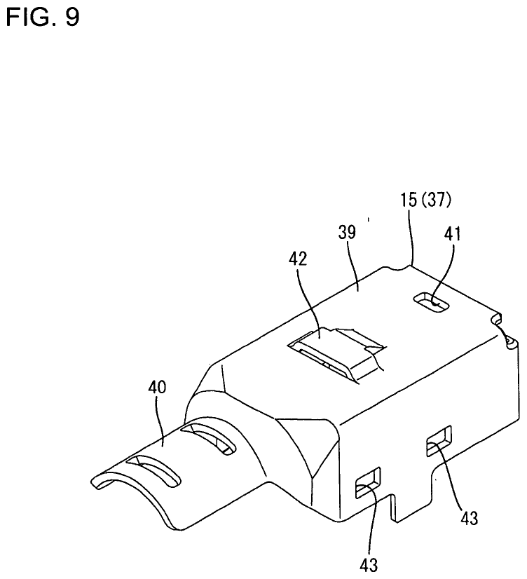

As shown in FIG. 9 and FIG. 13, the upper shell terminal 37 includes an upper shell portion 39 which covers an outer surface of the dielectric 13 from above and an upper connecting portion 40 which is provided continuously to the rear of the upper shell portion 39 and covers the terminal portion of the shield cable 11 from above. The upper connecting portion 40 is curved in an arc shape and is disposed along an upper outer peripheral surface of the shield member 21 exposed at the terminal portion of the shield cable 11. In a top board portion of the upper shell portion 39, an upper positioning hole 41 is provided to which the upper positioning portion 29 of the dielectric 13 is fittable, and an engaging protrusion 42 is provided behind the upper positioning hole 41 so as to project upward. In each of the left and right side plate portions of the upper shell terminal 37, shell holding holes 43 are provided at intervals in front and rear.

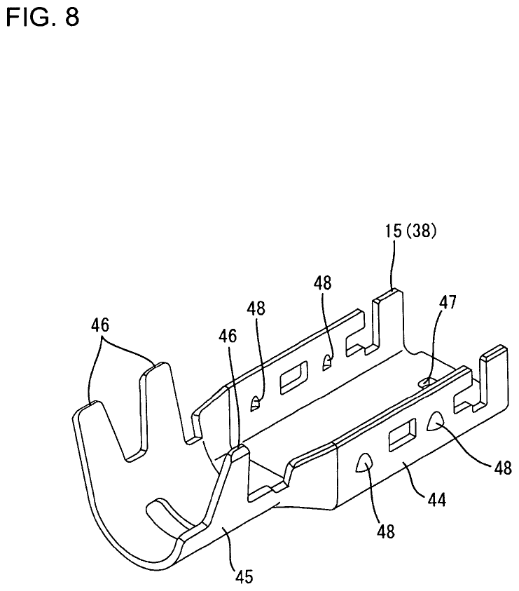

As shown in FIG. 8 and FIG. 13, the lower shell terminal 38 includes a lower shell portion 44 which covers the outer surface of the dielectric 13 from below and a lower connecting portion 45 which is provided continuously to the rear of the lower shell portion 44 and covers the terminal portion of the shield cable 11 from below. The lower connecting portion 45 has an arc-curved portion and a plurality of crimping pieces 46 projecting upward from both left and right sides of the curved portion. The lower connecting portion 45 is disposed along a lower outer peripheral surface of the shield member 21 exposed at the terminal portion of the shield cable 11, and as shown in FIG. 14, each crimping piece 46 is crimped so as to be wound around an outer surface of the upper connecting portion 40.

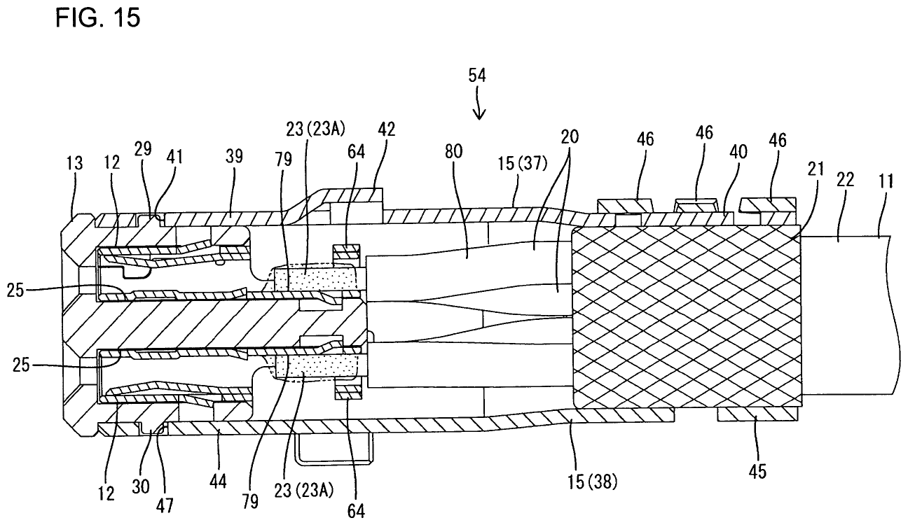

As shown in FIG. 15, a bottom plate portion of the lower shell portion 44 is provided with a lower positioning hole 47 to which the lower positioning portion 30 of the dielectric 13 is finable. In each of the left and right side plate portions of the lower shell portion 44, shell holding portions 48 are provided at intervals in front and rear. As shown in FIG. 14, each shell holding portion 48 has a form bulging outward, and is fittable into the corresponding shell holding hole 43.

[Housing]

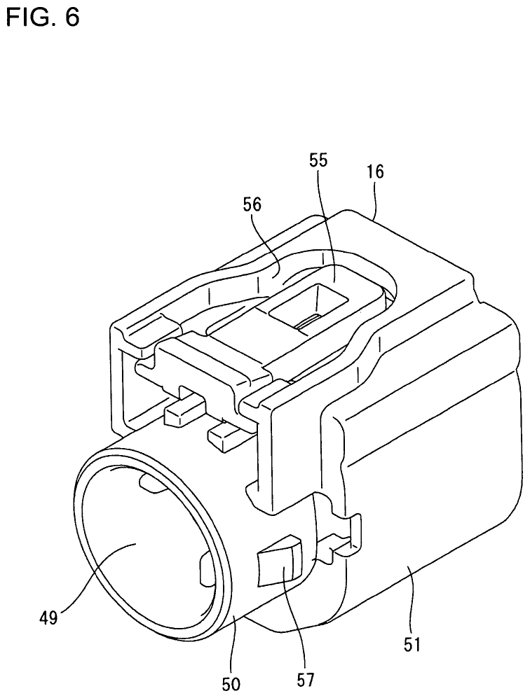

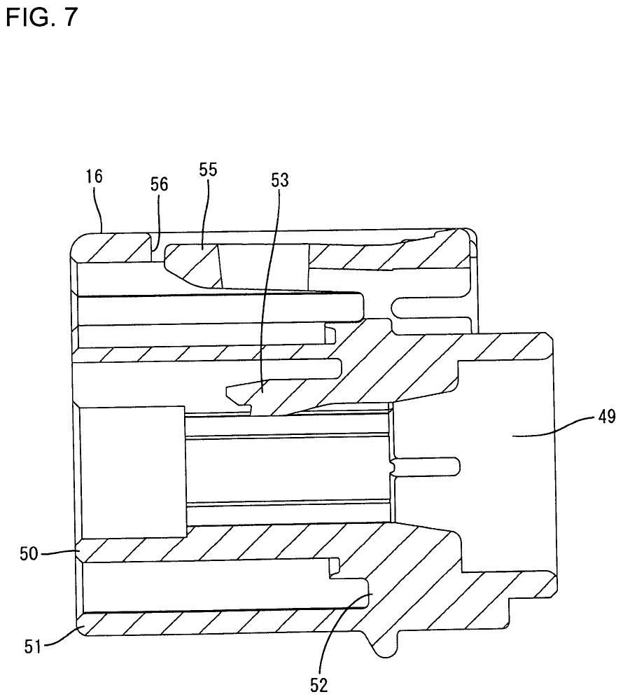

The housing 16 is an insulating synthetic resin material, and as shown in FIG. 6 and FIG. 7, includes an inner case portion 50 having a hollow insertion space 49 and an outer case portion 51 surrounding an outer periphery of the inner case portion 50. The inner case portion 50 and the outer case portion 51 are integrally connected with each other via a connecting portion 52, and as shown in FIG. 18, the hood portion 120 of the counterpart housing 116 is fittable into a space between the inner case portion 50 and the outer case portion 51 and in front of the connecting portion 52.

An inner upper surface of the inner case portion 50 is provided with an elastic engaging portion 53 protruding forward in a cantilever manner. Here, a cable side unit 54 in which the terminal portion of the shield cable 11, the dielectric 13, the outer conductor terminal 15, the inner conductor terminals 12 and the like are assembled is inserted into the insertion space 49 of the inner case portion 50. When the cable side unit 54 is inserted in the insertion space 49, the engaging protrusion 42 of the outer conductor terminal 15 is elastically engaged with the elastic engaging portion 53, as shown in FIG. 18, whereby the cable side unit 54 is retained to the housing 16.

On an upper surface of the inner case portion 50, a lock arm 55 is protrudingly provided which can be elastically displaced in a seesaw manner. The counterpart hood portion 120 is fitted into a space between the inner case portion 50 and the outer case portion 51, and the lock arm 55 elastically engages the lock protrusion 121, whereby the housing 16 is held to the counterpart housing 116 in a fitted state. As shown in FIG. 6, an upper wall of the outer case portion 51 is provided with a cut out portion 56 for exposing the lock arm 55. When a rear end portion of the lock arm 55 is pressed through the cut out portion 56, an engaging state of the lock arm 55 and the lock protrusion 121 is released, so that the housing 16 is allowed to be detached from the counterpart housing 116. On the outer surface of the rear portion of the inner case portion 50, lock protrusions 57 are provided in pairs on both left and right sides (only one is shown in FIG. 6).

[Rubber Plug]

The rubber plug 17 is made of rubber such as silicone rubber and has a circular cylindrical shape, and, as shown in FIG. 10, has a seal hole 58 penetrating therethrough in the front-rear direction. The shield cable 11 is inserted into the seal hole 58 of the rubber plug 17. As shown in FIG. 18, the sheath 22 of the shield cable 11 is elastically brought into close contact with an inner peripheral surface of the seal hole 58, whereby an outer periphery of the shield cable 11 is fluid-tightly sealed. When the cable side unit 54 is inserted into the insertion space 49 of the inner case portion 50, the rubber plug 17 is elastically brought into close contact with an inner surface of the inner case portion 50, whereby an inner periphery of the inner case portion 50 is fluid-tightly sealed.

[Rubber Plug Press Member]

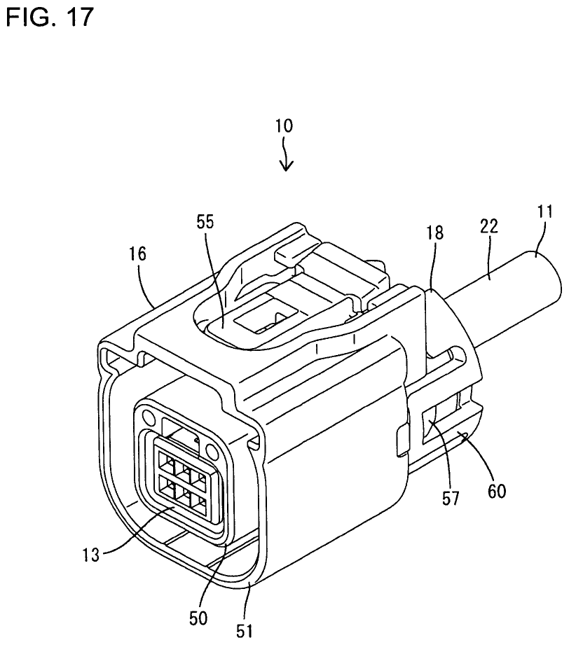

The rubber plug press member 18 is made of synthetic resin and has a cap shape, and, as shown in FIG. 10, includes a closing portion 59 that abuts against a rear surface of the rubber plug 17 and a pair of elastic lock pieces 60 which is projecting forward from left and right sides of the closing portion 59 and flexibly deformable. The closing portion 59 has an annular plate shape in a front view, and has a through hole 61 at its central portion through which the shield cable 11 is passed in a loosely inserted state. As shown in FIG. 17, the elastic lock pieces 60 are elastically engaged with the corresponding lock protrusions 57, whereby the rubber plug press member 18 is held to the housing 16. Further, as shown in FIG. 18, the rubber plug 17 abuts against the closing portion 59, whereby the rubber plug 17 is prevented from coming out of the housing 16.

[Rubber Ring]

The rubber ring 19 is made of rubber such as silicone rubber and has an annular shape, and is fitted onto the outer peripheral surface of the inner case portion 50 as shown in FIG. 18. When the counterpart hood portion 120 is fitted in the space between the inner case portion 50 and the outer case portion 51, the rubber ring 19 is elastically sandwiched between the inner case portion 50 and the hood portion 120, so that a gap between the housing 16 and the counterpart housing 116 is fluid-tightly sealed.

[Inner Conductor Terminal]

The inner conductor terminal 12 is formed integrally by punching a conductive metal plate having copper or aluminum as a main component into a predetermined shape and then performing bending and the like, and is formed to extend elongatedly in the front-rear direction as a whole. Specifically, as shown in FIG. 2, FIG. 3 and FIG. 5, the inner conductor terminal 12 includes a terminal connecting portion 62 having a square-cylindrical shape penetrating in the front-rear direction, a base plate portion 63 having a flat-plate shape and provided continuously to the rear of the terminal connecting portion 62, and a conductor holding portion 64 having a portal-frame shape and protrudingly provided in a rear end portion of the base plate portion 63. In the following description of a structure of the inner conductor terminal 12, a reference in a vertical direction is based on a state in which the inner conductor terminal 12 is accommodated in the terminal accommodation portion 25 on the upper side in the dielectric 13.

The terminal connecting portion 62 includes a bottom wall 65, a pair of side walls 66 raised from left and right ends of the bottom wall 65, an inner wall portion 67 laid from one side wall 66 to the other side wall 66, and an outer wall portion 68 laid from the other side wall 66 to the one side wall 66 and overlapped on the inner wall portion 67 from outside. The inner wall portion 67 and the outer wall portion 68 constitute a top wall 69.

As shown in FIG. 5, the inner wall portion 67 of the top wall 69 is provided with an elastic contact piece 70 bent downward in an angled shape. As shown in FIG. 18, the elastic contact piece 70 comes into contact with the tab 119, whereby the inner conductor terminal 12 is conductively connected to the counterpart terminal 112.

As shown in FIG. 5, the outer wall portion 68 of the top wall 69 is provided with a front engaging portion 71 projecting obliquely upward and rearward. The front engaging portion 71 is formed by bending and raising a plate-piece portion between square U-shaped notches cut in the outer wall portion 68.

The base plate portion 63 has a form extending rearward from the bottom wall 65 of the terminal connecting portion 62 without any step, and has substantially the same plate width as the bottom wall 65. As shown in FIG. 3, ribs 72 are provided so as to be bent and raised from left and right end portions of the base plate portion 63. Each rib 72 is formed to be integrally continuous with the side wall 66 of the terminal connecting portion 62, and its rising dimension from the base plate portion 63 is set sufficiently small.

As shown in FIG. 5, a rear engaging portion 73 projecting downward is provided at a position near a rear end of the base plate portion 63. The rear engaging portion 73 is formed to bulge downward via a notch made in the base plate portion 63. When the inner conductor terminal 12 is accommodated in the terminal accommodation portion 25 of the dielectric 13, the front engaging portion 71 is inserted into and engaged with the front engaging hole 28, and the rear engaging portion 73 is inserted into and engaged with the rear engaging hole 36, so that the inner conductor terminal 12 is retained to the terminal accommodation portion 25 so as not to come off.

As shown in FIG. 2, the conductor holding portion 64 includes a pair of connecting portions 74 rising from the left and right ends of the rear end portion of the base plate portion 63, an inner holding portion 75 laid from one of the connecting portions 74 to the other, and an outer holding portion 76 laid from the other of the connecting portions 74 to the one and overlapped on the inner holding portion 75 from outside. The inner holding portion 75 and the outer holding portion 76 constitute a holding main body 77. A rear portion of the inner conductor terminal 12 is formed into a square cylindrical shape by the base plate portion 63, both connecting portions 74, and the holding main body 77, and the conductor exposed portion 23A is inserted into the inside space thereof. As shown in FIG. 3, a rear surface opening of a square cylindrical portion at the rear portion of the inner conductor terminal 12 serves as a conductor introduction port 78 into which the conductor exposed portion 23A is inserted from the rear.

Each of the connecting portions 74 is formed to be integrally continuous with the rib 72, and its rising dimension from the base plate portion 63 is set sufficiently larger than that of the rib 72 and substantially the same as that of the side wall 66. One connecting portion 74 continued to the inner holding portion 75 is disposed on the same side as one side wall 66 continued to the inner portion of the top wall 69, and the other connecting portion 74 continued to the outer holding portion 76 is disposed on the same side as the other side wall 66 continued to the outer portion of the top wall 69.

Each of the connecting portions 74 is formed in a vertical plate shape, and each of the inner holding portion 75 and the outer holding portion 76 is formed in a horizontal plate shape. A corner portion in which the one connecting portion 74 is continued to the inner holding portion 75 and a corner portion in which the other connecting portion 74 is continued to the outer holding portion 76 are each formed in an arc shape. As shown in FIG. 5, the conductor holding portion 64 is disposed at a position overlapped with the rear engaging portion 73 with respect to the front-rear direction.

An upper surface of the base plate portion 63 is constituted as a soldering surface 79 to which the conductor exposed portion 23A of the electric wire 20 of the shield cable 11 is soldered. The left and right sides of the soldering surface 79 are partitioned by the ribs 72 and the connecting portions 74, and the holding main body 77 is opposed in the upper side of the rear portion of the soldering surface 79. The soldering surface 79 is disposed in a plane shape along the front-rear direction. Solder paste is coated in advance on the soldering surface 79 of the base plate portion 63.

[Assembly and Effect]

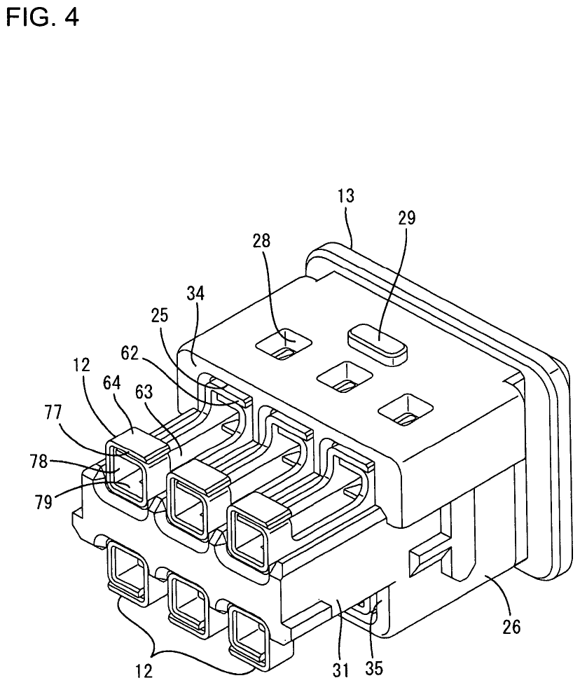

At a time of assembly, at first, as shown in FIG. 4 and FIG. 5, each inner conductor terminal 12 is accommodated into the corresponding terminal accommodation portion 25 of the dielectric 13. By an engaging action of the front engaging portion 71 and the rear engaging portion 73, each inner conductor terminal 12 is retained to the dielectric 13 so as not to come off. At this time, the terminal connecting portion 62 of the inner conductor terminal 12 is inserted in a front portion of the terminal accommodation portion 25 in the main body 26 of the dielectric 13, so that its outer periphery is covered. Meanwhile, the base plate portion 63 of the inner conductor terminal 12 is disposed being supported on the terminal support surface 32 in the projection piece 31 of the dielectric 13 with the soldering surface 79 being exposed. Before performing soldering which will be described later, the rubber plug 17 and the rubber plug press member 18 are externally inserted to the shield cable 11 in advance and placed at a rear position away from the terminal portion of the shield cable 11, as shown in FIG. 10.

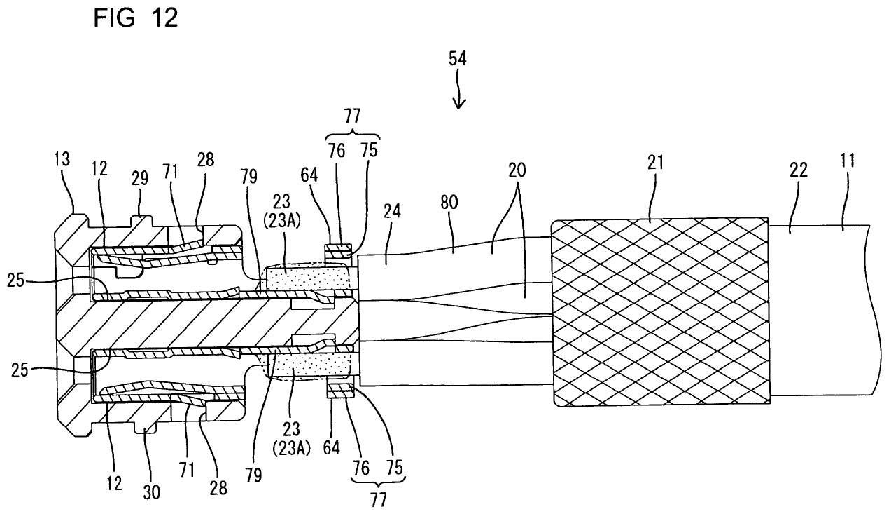

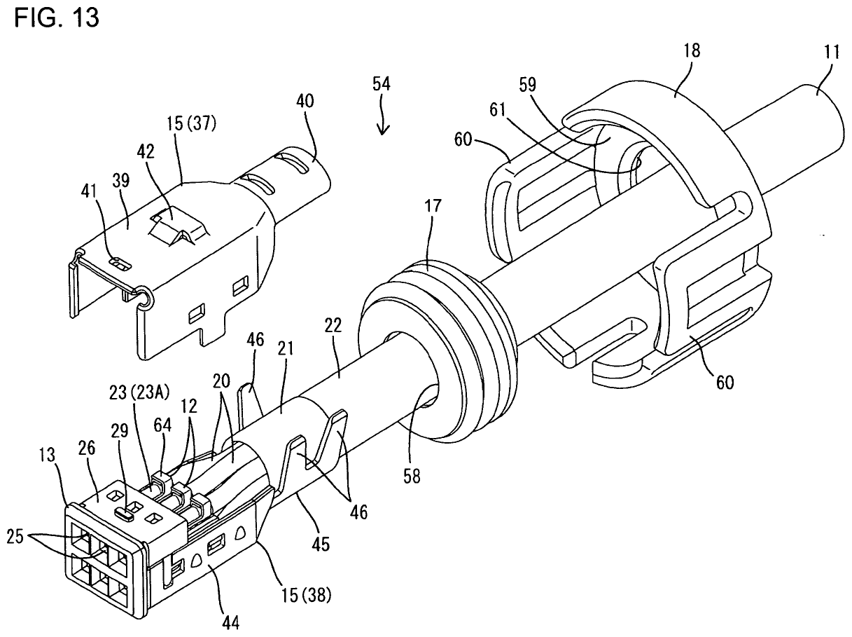

Subsequently, the conductor exposed portion 23A of each electric wire 20 is inserted into the inner space of the conductor holding portion 64 from the conductor introduction port 78, and is slid and placed on the soldering surface 79 of the inner conductor terminal 12. In the process of inserting the conductor exposed portion 23A, insertion operation of the conductor exposed portion 23A is guided by the conductor holding portion 64. When the insertion of the conductor exposed portion 23A is completed, a front end portion of the insulation coating 24 of the electric wire 20 is stopped in abutment against a rear surface of the projection piece 31, whereby an insertion amount of the conductor exposed portion 23A is defined. Further, as shown in FIG. 12, when the insertion of the conductor exposed portion 23A is completed, the inner holding portion 75 of the holding main body 77 is disposed close to the conductor exposed portion 23A so as to be contactable from above, and the connecting portions 74 are disposed close to the conductor exposed portion 23A so as to be contactable from both left and right sides.

By the way, each electric wire 20 exposed at the terminal portion of the shield cable 11 is slightly bent from an inside of the sheath 22 toward the corresponding inner conductor terminal 12, and the conductor exposed portion 23A located ahead of this bent portion 80 is passed through the conductor introduction port 78 while being corrected into an insertion posture facing forward. For this reason, the conductor exposed portion 23A on the soldering surface 79 tends to be displaced in a direction of being lifted up from the soldering surface 79 of the base plate portion 63 by a reaction force of the electric wire 20, particularly by an elastic restoring force of the bent portion 80. In the case of the present first embodiment, however, since the holding main body 77 of the conductor holding portion 64 is located at a position opposite to the displacement direction of the conductor exposed portion 23A, the conductor exposed portion 23A is prevented from further lifting by coming into contact with the holding main body 77. As a result, the conductor exposed portion 23A is well maintained in the state of being placed on the soldering surface 79 and in contact with the solder paste.

Thereafter, as shown in FIG. 12, the solder paste is heated and melted through the upper opening 34 and the lower opening 35 of the dielectric 13 together with the preliminary solder of the conductor exposed portion 23A, and then cooled to be solidified so that the conductor exposed portion 23A is connected to the soldering surface 79 of the base plate portion 63 via solder. Since lifting of the conductor exposed portion 23A is suppressed by the conductor holding portion 64 while the soldering is performed, an occurrence of a soldering defect due to the lifting of the conductor exposed portion 23A can be prevented.

Subsequently, the lower positioning portion 30 of the dielectric 13 is fitted into the lower positioning hole 47 of the lower shell portion 44, and as shown in FIG. 13, the main body 26 and the projection piece 31 of the dielectric 13 are placed on the lower shell portion 44, and the terminal portion (exposed portion) of the shield member 21 is placed on the lower connecting portion 45. As a result, the dielectric 13 and the terminal portion of the shield cable 11 are supported on the lower shell terminal 38.

Then, the upper positioning portion 29 of the dielectric 13 is fitted into the upper positioning hole 41 of the upper shell portion 39, and as shown in FIG. 14, the upper sides of the main body 26 and the projection piece 31 of the dielectric 13 are covered by the upper shell portion 39, and the upper side of the terminal portion (exposed portion) of the shield member 21 is covered by the upper connecting portion 40. The side plate portions of the upper shell portion 39 are overlapped on the side plate portions of the lower shell portion 44 from outside, and the shell holding portions 48 are respectively inserted and fitted into the shell holding holes 43. In that state, each crimping piece 46 upwardly projecting is crimped and attached to the outer surface of the upper connecting portion 40. Thus, the upper shell terminal 37 and the lower shell terminal 38 are connected to the shield member 21, and as shown in FIG. 15, united together sandwiching the inner conductor terminals 12, the dielectric 13, and the terminal portion of the shield member 21 therebetween, whereby the dielectric 13 and the terminal portion of the shield cable 11 are shielded.

Subsequently, the assembled cable side unit 54 as described above is inserted from the rear into the insertion space 49 of the inner case portion 50 of the housing 16 and is retained to the housing 16 by an engaging action of the engaging protrusion 42 and the elastic engaging portion 53. Further, the rubber plug 17 is inserted into the insertion space 49 from the rear, and then the rubber plug press member 18 is externally fitted to the rear portion of the inner case portion 50 and retained to the housing 16 while preventing the rubber plug 17 from coming off by an engaging action of the elastic lock pieces 60 and the lock protrusions 57. Finally, as shown in FIG. 18, the housing 16 is fitted to the counterpart housing 116, the dielectric 13 enters the hood portion 120, and the tab 119 of each counterpart terminal 112 is inserted into and connected to the terminal connecting portion 62 of each inner conductor terminal 12.

As described above, according to the first embodiment, the conductor exposed portion 23A is in a state of being prevented from lifting from the soldering surface 79 by coming into contact with the conductor holding portion 64, and in that state, the conductor exposed portion 23A is soldered onto the soldering surface 79. Accordingly, soldering can be performed smoothly without any trouble, and as a result, assembling workability of the shield connector 10 can be improved.

Further, the conductor holding portion 64 includes the holding main body 77 disposed opposite to the soldering surface 79, and the connecting portions 74 connecting the holding main body 77 and the base plate portion 63. Therefore, the inner conductor terminal 12 can be easily manufactured.

Further, the connecting portions 74 are raised in pairs from the base plate portion 63, and the pair of connecting portions 74, the holding main body 77, and the base plate portion 63 form a cylindrical shape. Therefore, strength of the rear portion of the inner conductor terminal 12 can be enhanced. In addition, since the holding main body 77 is provided double in a direction opposite to the soldering surface 79, the cylindrical shaped portion is prevented from easily being opened.

Still further, the shield connector 10 includes: the insulating dielectric 13 having the terminal accommodation portions 25 for accommodating the inner conductor terminals 12; and the outer conductor terminal 15 surrounding the inner conductor terminals 12 via the dielectric 13 and connected to the shield member 21 of the shield cable 11. The dielectric 13 has the upper opening 34 and the lower opening 35 as an opening portion not covering the soldering surface 79 of each inner conductor terminal 12 accommodated in the terminal accommodation portion 25. Accordingly, heat treatment of the soldering can be performed through the upper opening 34 and the lower opening 35 in the state where the inner conductor terminals 12 are accommodated in the terminal accommodation portions 25 of the dielectric 13, with the result that the workability is further improved.

### Second Embodiment

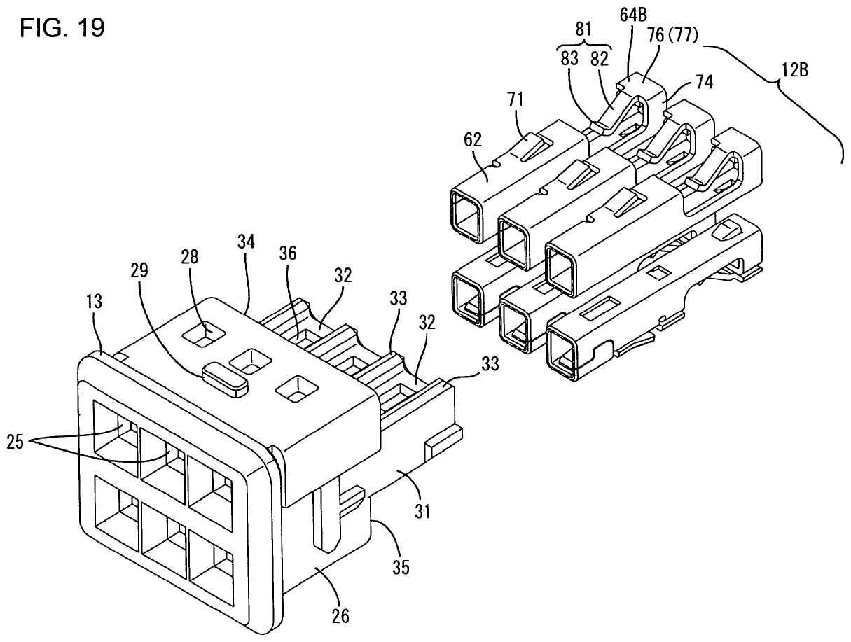

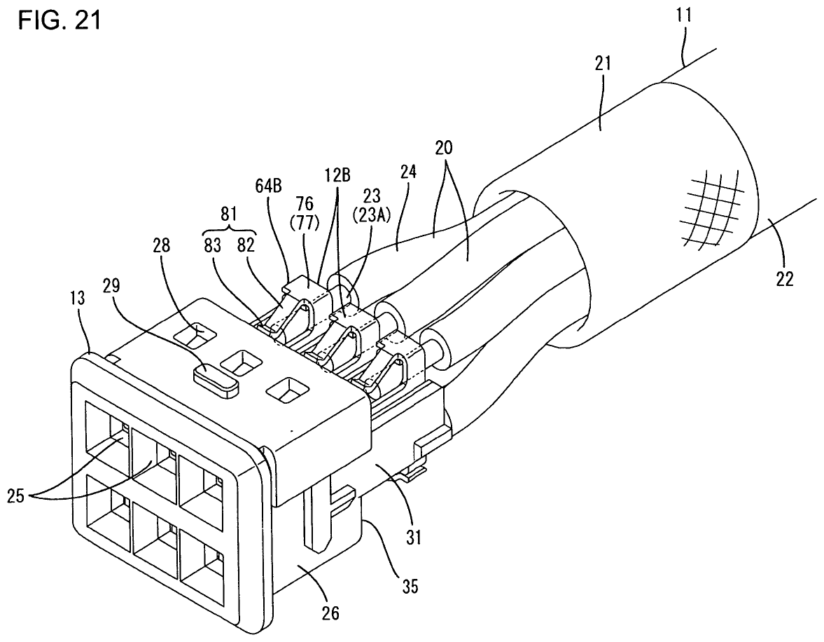

A second embodiment of the present invention is shown in FIG. 19 to FIG. 21. The second embodiment is different from the first embodiment in a structure of a conductor holding portion 64B. However, structures of other portions of an inner conductor terminal 12B than the conductor holding portion 64B and the structures of other portions (members) constituting the shield connector 10 are the same as those of the first embodiment. Therefore, in the following description, the same or corresponding structure as or to that of the first embodiment is denoted by the same reference sign as that of the first embodiment, and an overlapping description will be omitted. In the following description of the structure of the inner conductor terminal 12 B, a reference in the vertical direction is based on a state in which the inner conductor terminal 12B is accommodated in the terminal accommodation portion 25 on the upper side in the dielectric 13.

The conductor holding portion 64B includes the pair of connecting portions 74 and the holding main body 77 composed of the inner holding portion 75 and the outer holding portion 76, and constitutes a square cylindrical portion with the base plate portion 63. These structures are the same as in the first embodiment.

In the case of the second embodiment, the holding main body 77 is provided with an elastic holding piece 81 extending forward in a cantilever manner from the outer holding portion 76. Specifically, the elastic holding piece 81 has a constant width over substantially the entire length in an extending direction, and includes: an extending portion 82 extending obliquely downward and forward from a laterally middle portion (a portion excluding left and right end portions) of the outer holding portion 76; and a holding main body portion 83 bent so as to jump up from a distal end of the extending direction of the extending portion 82.

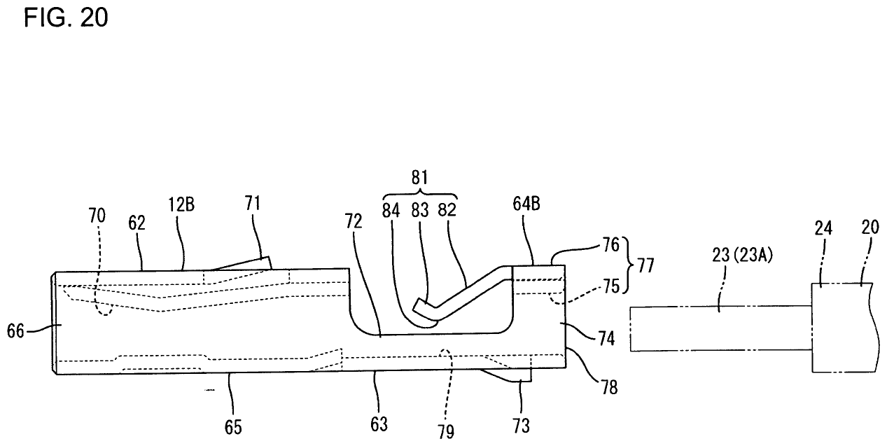

As shown in FIG. 20, the extending portion 82 is longer in the front-rear direction than the outer holding portion 76, and is inclined linearly so as to gradually approach the soldering surface 79 as it goes forward. The holding main body portion 83 has a short front-rear length, and is inclined linearly so as to be gradually away from the soldering surface 79 as it goes forward. A lower surface of the holding main body portion 83 includes a portion continued to the extending portion 82. The portion serves as a conductor pressing portion 84 having a curved surface shape configured to come into contact with the conductor exposed portion 23A, and is disposed at the position closest to the soldering surface 79.

The elastic holding piece 81 is flexibly deformable in the vertical direction with a portion connected to the outer holding portion 76 serving as a fulcrum. When the elastic holding piece 81 is in a natural state, a clearance between the conductor pressing portion 84 and the soldering surface 79 is slightly smaller than a diameter of the conductor exposed portion 23A.

In the case of the second embodiment, in a process of inserting the conductor exposed portion 23A into an inner space of the conductor holding portion 64B from the conductor introduction port 78, the conductor exposed portion 23A slidingly comes into contact with the extending portion 82, so that the elastic holding piece 81 is flexibly deformed. When the insertion of the conductor exposed portion 23A is completed, the conductor pressing portion 84 of the holding main body portion 83 is in contact with the conductor exposed portion 23A, and the conductor exposed portion 23A is in a state of being elastically sandwiched between the soldering surface 79 of the base plate portion 63 and the holding main body portion 83. At this time, flexibility of the elastic holding piece 81 is maintained, so that the conductor exposed portion 23A is held in a state of being pressed onto the soldering surface 79 by receiving an elastic force of the elastic holding piece 81. The subsequent soldering process, the assembly process of the shield connector 10, and the connector fitting process are the same as in the first embodiment.

According to the second embodiment, the conductor exposed portion 23A is reliably prevented from lifting from the soldering surface 79 of the base plate portion 63 by the pressing action of the elastic holding piece 81. In particular, in the case of the second embodiment, since a height of a solder layer precoated on the soldering surface 79 of the base plate portion 63 is relatively low, it is a great advantage that lifting of the conductor exposed portion 23A can be reliably suppressed by the elastic holding piece 81. Since the curved surface portion of the conductor pressing portion 84 is made into contact with the conductor exposed portion 23A, the conductor exposed portion 23A is less likely to be damaged.

### Third Embodiment

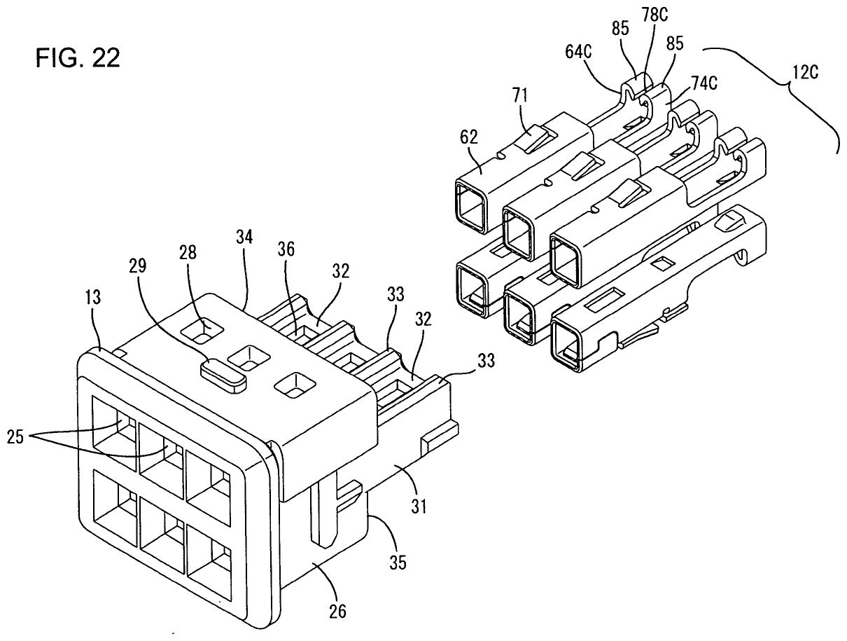

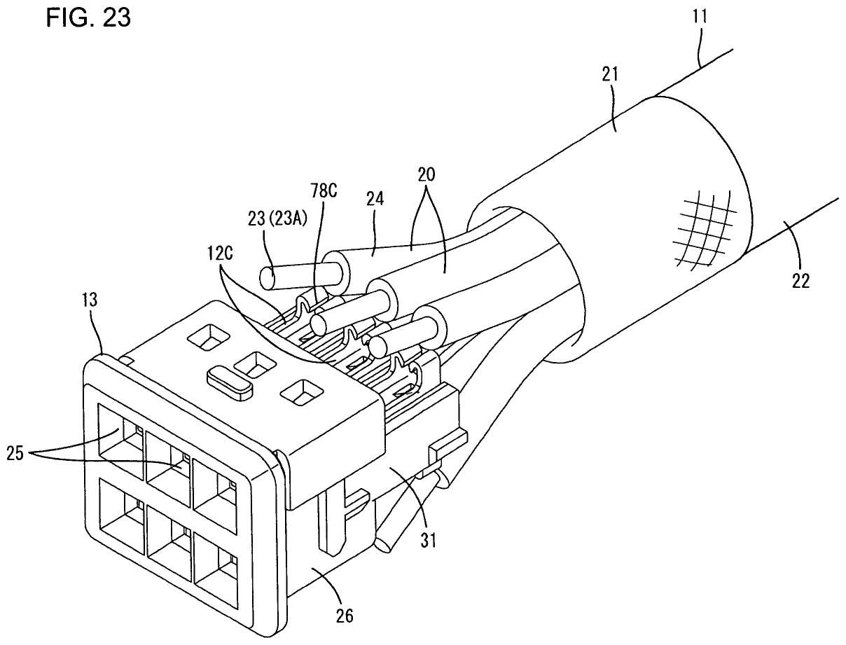

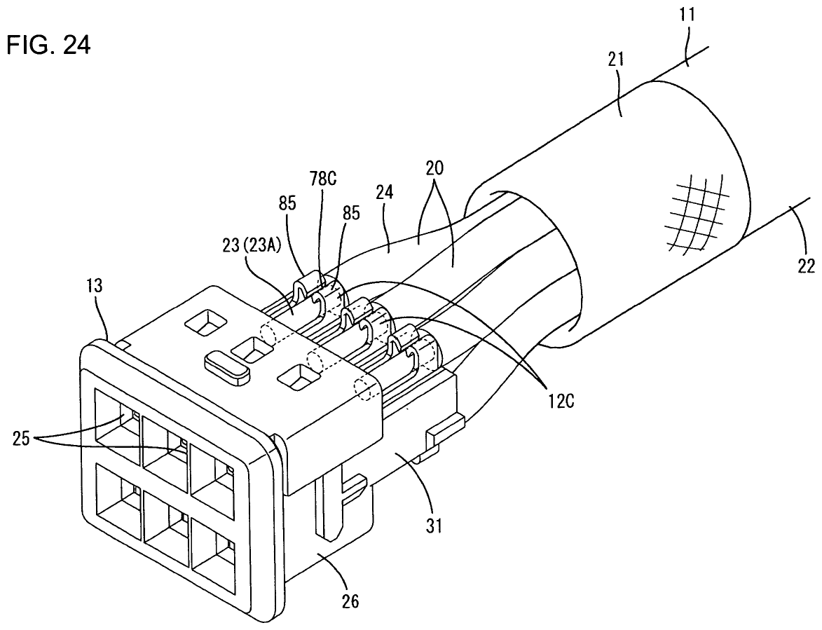

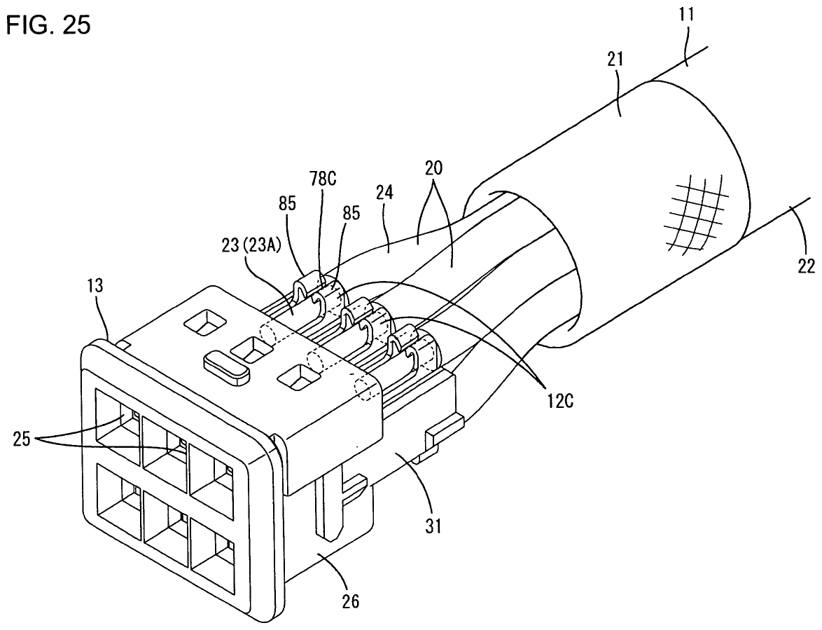

A third embodiment of the present invention is shown in FIG. 22 to FIG. 24. The third embodiment is different from the first embodiment in a structure of a conductor holding portion 64C. However, structures of other portions of an inner conductor terminal 12C than the conductor holding portion 64C and the structures of other portions (members) constituting the shield connector 10 are the same as those of the first embodiment. Therefore, in the following description, the same or corresponding structure as or to that of the first embodiment is denoted by the same reference sign as that of the first embodiment, and an overlapping description will be omitted. In the following description of the structure of the inner conductor terminal 12C, a reference in the vertical direction is based on a state in which the inner conductor terminal 12C is accommodated in the terminal accommodation portion 25 on the upper side in the dielectric 13.

The conductor holding portion 64C includes a pair of connecting portions 74C rising from the left and right ends of the rear end portion of the base plate portion 63, and a pair of guide portions 85 curved inward in a semicircular arc shape so as to approach each other from upper end portions of both connecting portions 74C. The connecting portion 74C is formed to be integrally continuous with the rib 72, and has substantially the same width from a portion continued to the rib 72 to the guide portion 85.

Upper ends and lower ends of both guide portions 85 are arranged at the same height with each other and along the front-rear direction. Each of opposed surfaces of both guide portions 85 has a curved surface shape curved from the upper end to the lower end, and the lower end portion is slidable with a side surface portion of the conductor exposed portion 23A. Since the conductor exposed portion 23A has a single core shape by a preliminary soldering, rigidity of the conductor exposed portion 23A is maintained even when the side surface portion thereof slides on the opposed surfaces of the guide portions 85.

A conductor introduction port 78C in defined between the opposed surfaces of both guide portions 85 into which the conductor exposed portion 23A is insertable from above. An opening width of the conductor introduction port 78C is slightly smaller than the diameter of the conductor exposed portion 23A. The inner and outer surfaces of the guide portion 85, including the opposed surface, are formed in the curved surface shape in their entirety so as not to damage the conductor exposed portion 23A even when the conductor exposed portion 23A comes into contact therewith.

In the case of the third embodiment, the conductor exposed portion 23A of each electric wire 20 is displaced so as to approach the soldering surface 79 from a direction intersecting with a length direction (from above and below) through the conductor introduction port 78C. Then, the side surface portion of the conductor exposed portion 23A slides on the opposed surfaces of both guide portions 85, and the conductor holding portion 64C is flexibly deformed so as to be slightly opened with respective proximal portions of both connecting portions 74C serving as approximate fulcrums. Subsequently, when the conductor exposed portion 23A is placed on the soldering surface 79, the conductor holding portion 64C elastically returns, and both guide portions 85 are arranged to be contactable with the conductor exposed portion 23A from above. As a result, the conductor exposed portion 23A is prevented from lifting from the soldering surface 79. The subsequent soldering process, the assembly process of the shield connector 10, and the connector fitting process are the same as in the first embodiment.

According to the third embodiment, since the conductor exposed portion 23A can be inserted from the conductor introduction port 78C toward the soldering surface 79, the workability is further improved.

### Other Embodiments

Other embodiments will be briefly described below.

(1) In the first to third embodiments, the connecting portion may be raised from only one of the left and right ends of the base plate portion, and the conductor holding portion may be formed into an inverted L shape or an inverted J shape in a front view.

(2) In the second embodiment, the elastic holding piece may project from the inner holding portion.

(3) In the third embodiment, the conductor exposed portion may be not slid on the opposed surfaces of both guide portions but may be inserted from the rear (in the length direction) into the inner space of the conductor holding portion as in the first and second embodiments.

(4) The inner conductor terminal having the conductor holding portion may be provided on the male terminal fitting (which is the counterpart terminal; a reference sign 64D in FIG. 18 corresponds to the conductor holding portion). In this case, the terminal connecting portion 62 includes a tab projecting forward from the cylindrical portion.

### REFERENCE SIGNS LIST

10 shield connector
11 shield cable
12, 12B, 12C inner conductor terminal
13 dielectric
15 outer conductor terminal
21 shield member
25 terminal accommodation portion
62 terminal connecting portion
63 base plate portion
64, 64B, 64C conductor holding portion
74, 74C connecting portion
77 holding main body
78, 78C conductor introduction port
79 soldering surface
81 elastic holding piece
85 guide portion
112 counterpart terminal

1. An inner conductor terminal for a shield connector, comprising:
a terminal connecting portion to be connected to a counterpart terminal;
a base plate portion provided continuously with the terminal connecting portion and having a soldering surface on which a conductor of a shield cable is placed and soldered, the shield cable including the conductor and an insulation coating covering an outer periphery of the conductor, and the conductor being exposed at a terminal portion of the shield cable; and
a conductor holding portion arranged opposite to the conductor so as to be contactable with the conductor placed on the soldering surface in a direction where the conductor is separated from the soldering surface.

2. The inner conductor terminal according to claim 1, wherein the conductor holding portion includes a holding main body arranged opposite to the soldering surface, and a connecting portion connecting the holding main body and the base plate portion.

3. The inner conductor terminal according to claim 2, wherein
a pair of the connecting portions are raised in pairs from the base plate portion,
the pair of connecting portions, the holding main body, and the base plate portion constitute a cylindrical form, and
the holding main body is provided double in a direction opposite to the soldering surface.

4. The inner conductor terminal according to claim 1, wherein the conductor holding portion includes an elastic holding piece that is flexibly deformable and presses and holds the conductor against the soldering surface.

5. The inner conductor terminal according to claim 4, wherein
the conductor holding portion includes a holding main body disposed opposite to the soldering surface, and a connecting portion connecting the holding main body and the base plate portion,
a conductor introduction port is formed in an inner space partitioned by the connecting portion, the holding main body, and the base plate portion, the conductor introduction port being opened to an opposite side to a side of the terminal connecting portion, and
the elastic holding piece includes a portion projecting from the holding main body toward the side of the terminal connecting portion so as to gradually approach the soldering surface.

6. The inner conductor terminal according to claim 1, wherein
the conductor holding portion includes a pair of guide portions approaching each other toward a side of the base plate portion, and
a conductor introduction port is formed between the pair of guide portions so as to be opened toward the soldering surface.

7. A shield connector including the inner conductor terminal according to claim 1, comprising:
an insulating dielectric including a terminal accommodation portion for accommodating the inner conductor terminal; and
an outer conductor terminal surrounding the inner conductor terminal via the dielectric and connected to a shield member of the shield cable,
wherein the dielectric includes an opening portion not covering the soldering surface of the inner conductor terminal accommodated in the terminal accommodation portion.
